(19) United States
(12) Patent Application Publication
(10) Pub. No.: US 2006/0278320 A1
(43) Pub. Date: Dec. 14, 2006

(54) Vehicle tires with steel belt cords and with a dipole antenna arranged in the area of the tread

(75) Inventors: Manfred Ellmann, Buch am Erlbach (DE); Lothar Laske, Gilching (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/508,918

(22) Filed: Aug. 24, 2006

Related U.S. Application Data
(63) Continuation of application No. PCT/EP05/00820, filed on Jan. 28, 2005.

(30) Foreign Application Priority Data
Feb. 24, 2004 (DE) 10 2004 008 929.9

(51) Int. Cl. B60C 9/18

(52) U.S. Cl. 152/534; 152/152.1

(57) ABSTRACT

A vehicle tire having steel belt cords is provided with a dipole antenna arranged in the area of the tire tread for data transmission, in particular for a transponder for transmitting energy and measured quantities. The dipole antenna cooperates with a sending and receiving antenna arranged on the vehicle. The dipole antenna is arranged essentially across the steel belt cords. If the belt angles of the two intersecting plies of steel belt cords with respect to the longitudinal axis of the tire profile are not the same, then the dipole antenna with its longitudinal axis is aligned essentially perpendicular to the axis of symmetry between the two intersecting plies of steel belt cords. The dipole antenna preferably has an effective dipole length of 6 cm when using a transmission frequency of 2.45 GHz. The vehicle's sending and receiving antenna is preferably aligned so that is has essentially the same polarization plane as the dipole antenna.

This application is a Continuation of PCT/EP2005/000820, filed Jan. 28, 2005, and claims the priority of DE 10 2004 008 929.9, filed Feb. 24, 2005, the disclosures of which are expressly incorporated by reference herein.

### BACKGROUND AND SUMMARY OF THE INVENTION

The present invention relates to a vehicle tire having steel belt cords and a dipole antenna arranged in the area of the tire tread for data transmission, in particular for a transponder for transmitting energy and measured variables, optionally data, cooperating with a sending and receiving antenna situated on the vehicle.

For the sake of example, reference is made to German patent publication DE 102 23 800 A1 for the technical background. Data and physical measured quantities, in particular the tire air pressure and/or tire temperature and/or mechanical tire stresses can be transmitted relatively easily to a receiving antenna mounted on the vehicle chassis and then forwarded from there to an electronic analyzer unit where the tire air pressure, for example, is monitored. Various mounting sites for the sending and receiving antenna that is fixedly mounted on the chassis are known, e.g., opposite the top tread section of the tire, i.e., on the inside of the vehicle wheel housing in the cover area or fender area. The antenna in the tire may be designed as a ring antenna, for example, and preferably arranged in the tread of the tire, and therefore near the receiving antenna, as disclosed in German patent publication DE 102 17 215 A1. The inner side wall of the vehicle wheel house is another preferred mounting site for the receiving antenna, whereby this antenna and its periphery can be protected from soiling and damage as much as possible. Then a tire ring antenna should be provided in and/or on the side wall of the tire facing this inner side wall of the vehicle wheel house, as disclosed in European patent publication EP 1 344 658 A1, for example, because otherwise the transmission of data (and energy) would not be ensured because the distance is too great.

However, there are disadvantages to mounting a ring antenna in the side wall of the tire because it is necessary to ensure that the tire is mounted on the wheel rim in such a way that when the vehicle wheel is mounted, the tire ring antenna is facing the sending and transmitting antenna fixedly mounted on the vehicle. As a result, right and left tires must be kept in stock in the case of directional tires (and this includes most M/S tires today); this would double the number of variants, already quite numerous, that must be kept in stock by the vehicle manufacturer in production of vehicles and in spare parts trade.

The telemetry communication between the tire transponder and the vehicle is interrupted if the correct tire-side correspondence with the vehicle is disregarded, and this is true of directional tires as well as those that are not, and this would cause a disturbance and should therefore be avoided. However, especially in the case of so-called normal tires which are not directional, in particular when performing a tire change outside of a specialized service shop, the correct side allocation might not be taken into account so a large number of interference cases would have to be feared in the case of the known vehicle tires described here having a ring antenna running peripherally on a side wall.

In addition to the ring antennas explained so far, the use of dipole antennas for transmission of data and energy between a vehicle tire and the vehicle chassis is also known, as disclosed in German patent publication DE 102 23 800 A1, for example, which was cited in the introduction. It is proposed in that document that the dipole antennas should always be mounted on the inside of the tire with the transponder in the area of the tire bead or on the tire sidewall, but this again leads to the problem described above with regard to the correct side allocation. As an alternative according to this publication, the transponder with the dipole antenna may be arranged in the area of the tire tread.

With such an arrangement of a dipole antenna in the tread area of an automotive tire, the problem described here with regard to the correct side allocation may be solved but the usual vehicle tires are known to have plies of steel belt cords, especially in the tread area, which would lead to unwanted damping of the transmission power between the dipole antennas on the tire side and the transmission and receiving antenna on the chassis side.

The object of the present invention is to find an expedient measure to solve the problems described here.

The solution to these problems for a vehicle tire with steel belt cords is characterized in that the dipole antenna is arranged essentially across the steel belt cords.

Other objects, advantages and novel features of the present invention will become apparent from the following detailed description of the invention when considered in conjunction with the accompanying drawings.

If the dipole antenna and preferably with it the respective transponder are mounted on or beneath the so-called inliner of the tire in the central area of the tire tread, this ensures in a manner that rules out mixups that the dipole antenna or transponder antenna will always be running in the same alignment with the antenna fixedly mounted on the vehicle regardless of which side of the tire is mounted on the wheel and which side of the vehicle the wheel is mounted on. For use, an open straight dipole antenna which need only have an effective dipole length on the order of magnitude of 6 cm when using an internationally allowed transmission frequency of 2.45 GHz may be used here, but deviations by approximately 15% in either direction are possible. A dipole antenna having such short dimensions can easily be accommodated together with the respective transponder in a steel-belted tire of the type customarily used for passenger vehicles, for example.

However, the dipole antenna is only a short distance of a few millimeters away from the steel belt cords usually provided in the tread area of automotive tires and therefore its effect is dampened. It has now been discovered that this damping is relatively great if the dipole antenna runs with its longitudinal direction parallel to the longitudinal direction of the belt cords but is relatively weak if it runs with its longitudinal axis essentially at a right angle to, i.e., across, the belt cords (i.e., at an angle on the order of 90°).

### BRIEF DESCRIPTION OF THE DRAWINGS

FIG. 1 is a schematic illustration of a vehicle tire steel belt and a dipole antenna in accordance with an embodiment of the present invention.

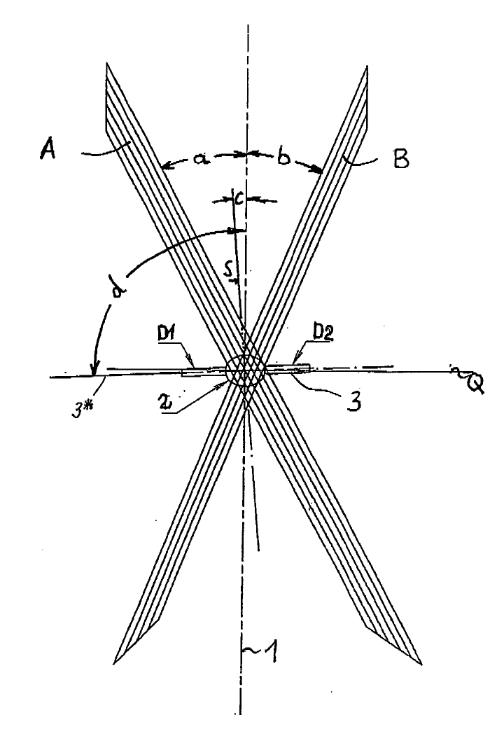

### DETAILED DESCRIPTION

The steel belt cords in automotive tires are usually arranged in intersecting plies, namely in an angle range of ±20° to ±30° with respect to the longitudinal axis of the tread profile, whereby this longitudinal axis runs perpendicular to the axis of rotation of the tire. Thus a relatively low antenna damping of the transponder dipole antenna can be achieved if the antenna is arranged across the belt fibers and/or steel belt cords as closely as possible and thus lie across the longitudinal axis of the tire profile. In this regard, reference is made to the accompanying schematic diagram which shows two intersecting plies of steel belt cords in the tread of an inventive tire with a built-in dipole antenna and transponder.

The longitudinal axis of the tread or tire profile is labeled as 1, forming an angle of 90° with this axis of rotation Q of the tire in a perpendicular projection onto the axis of rotation Q of the tire. A first ply of steel belt cords in the tire tread is labeled as A and a second ply intersecting the former is labeled as B. The first ply A is inclined with respect to the longitudinal axis 1 by an angle a on the order of magnitude of 28° and the second ply B is inclined by an angle b on the order of magnitude of 22° with respect to the longitudinal axis 1, which corresponds to a conventional design of a steel-belted tire having asymmetrical belt angles.

A so-called transponder, which is basically known, is labeled with reference numeral 2; the transponder picks up measurement data from the vehicle tire and converts it in a suitable form which is then transmitted via an antenna from the tire to a sending and receiving antenna on the vehicle, not shown in the figure. The antenna which is provided in the tire is designed as dipole antenna 3 having two dipoles D1, D2 which protrude laterally from the transponder 2. The longitudinal axis of this dipole antenna 3 is labeled with reference numeral 3*.

The dipole antenna 3 with its longitudinal antenna 3* here is arranged essentially perpendicular to the axis of symmetry s between the two intersecting plies A, B of steel belt cords, whereby their axis of symmetry s runs obliquely to the longitudinal axis 1 of the tire profiled by the angle c=(a−b)/2=(28°−22°)/2=3°. The antenna dipole and/or its longitudinal axis 3* then does not run at an angle of 90° to the longitudinal axis 1 of the tire profile but instead is inclined by the angle d=90°+c=90°+3°=93°. Since the belt angles a and b are of course known in tire production, the transponder dipole antenna 3 may thus be installed so it is aligned exactly in the angle d according to the formula given above for d.

The transmission quality between the sending and receiving antenna mounted fixedly on the vehicle and the dipole antenna 3 of the tire transponder 2 can be optimized by aligning the antenna fixedly mounted on the vehicle in such a way that it has the same or almost the same polarization plane as the transponder dipole antenna 3 with dipoles D1, D2. With the proposed measures, the total damping of 48 dB can be reduced to 42 dB in comparison with the least favorable arrangement; experience has shown that this is enough to significantly improve the transmission stability of the entire wireless path and/or permits higher energy resources for especially high wear sensors in the transponder.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle tire, comprising:
at least two steel belt cords arranged in a tread area of the tire, wherein a belt angle relative to a longitudinal axis of the tire of each of two intersecting steel belt cords are not equal; and
a dipole antenna for data transmission arranged in the tread area of the tire and configured to communicate with a sending and receiving antenna arranged on a vehicle,
wherein the dipole antenna is arranged across the steel belt cords essentially aligned with a longitudinal axis through the antenna disposed essentially perpendicular to an axis of symmetry between the two intersecting steel belt cords.

2. The vehicle tire as claimed in claim 1, wherein the dipole antenna has an effective dipole length of approximately 5 cm to 7 cm.

3. The vehicle tire as claimed in claim 2, wherein the dipole antenna has an effective dipole length of approximately 6 cm.

4. An automobile, comprising:
a vehicle body;
sending and receiving antenna arranged on a vehicle; and
at least one vehicle tire which includes
at least two steel belt cords arranged in a tread area of the tire, wherein a belt angle relative to a longitudinal axis of the tire of each of two intersecting steel belt cords are not equal; and
a dipole antenna for data transmission arranged in the tread area of the tire and configured to communicate with the sending and receiving antenna,
wherein the dipole antenna is arranged across the steel belt cords essentially aligned with a longitudinal axis through the antenna disposed essentially perpendicular to an axis of symmetry between the two intersecting steel belt cords,
wherein the sending and transmitting antenna is oriented so that it has essentially the same polarization plane as the dipole antenna.

5. The automobile as claimed in claim 4, wherein the dipole antenna has an effective dipole length of approximately 5 cm to 7 cm.

6. The automobile as claimed in claim 5, wherein the dipole antenna has an effective dipole length of approximately 6 cm.
